(19) United States
(12) Patent Application Publication
(10) Pub. No.: US 2020/0286054 A1
(43) Pub. Date: Sep. 10, 2020

(54) PAYMENT PROCESSING DEVICE USING BIOMETRIC AUTHENTICATION, PAYMENT PROCESSING METHOD USING BIOMETRIC AUTHENTICATION, SETTLEMENT SYSTEM USING BIOMETRIC AUTHENTICATION, AND SETTLEMENT PROGRAM USING BIOMETRIC AUTHENTICATION

(71) Applicant: NEC Corporation, Tokyo (JP)

(72) Inventor: Kazuma UMEZU, Tokyo (JP)

(73) Assignee: NEC Corporation, Tokyo (JP)

(21) Appl. No.: 16/811,758

(22) Filed: Mar. 6, 2020

(30) Foreign Application Priority Data
Mar. 8, 2019 (JP) 2019-042831

(51) Int. Cl. G06Q 20/10; G06Q 20/40; G06Q 20/34

(52) U.S. Cl. CPC G06Q 20/102; G06Q 20/346; G06Q 20/40145

(57) ABSTRACT

[Problem] The present invention reduces inconvenience that may occur due to a settlement being made at each store for each purchase.

[Solution] The present invention provides a processing device 10 including a billing information registration unit 12 that acquires purchase information including customer information about a customer who takes a purchase action and billed amount information for the purchase action, and stores, in a storage unit 13, the customer information and the billed amount information in association with each other, and a fixing unit 14 that acquires a settlement request including the customer information, then fixes a billing content, based on the billed amount information being stored in association with the customer information included in the acquired settlement request, and outputs billing content information indicating the fixed billing content.

### CROSS-REFERENCE TO RELATED APPLICATION

This application is based upon and claims benefit of priority from Japanese patent application No. 2019-042831, filed on Mar. 8, 2019, the disclosure of which is incorporated herein in its entirety by reference.

### TECHNICAL FIELD

The present invention relates to a processing device, a processing method, a settlement system, and a program.

### BACKGROUND ART

PTL 1 discloses a settlement means using biometric authentication.

### CITATION LIST

### Patent Literature

[PTL 1] Japanese Unexamined Patent Application Publication No. 2017-123202

### SUMMARY OF INVENTION

### Technical Problem

In recent years, a service (face settlement service) for making a settlement by facial authentication is provided. Since a settlement is made by the facial authentication, a problem that cash, a credit card, and the like are lost or fail to be brought is solved. However, the known facial settlement service adopts a mechanism of performing deduction from a credit card at a point in time when the facial authentication is performed. Thus, in order to provide the facial settlement service at a store, a system of a credit card settlement also needs to be introduced at the store in addition to the facial authentication system, and thus an obstacle for the system introduction is high.

An issue of the present invention is to reduce inconvenience that may occur due to a settlement being made at each store for each purchase.

### Solution to Problem

The present invention provides a processing method including:

a billing information registration step of acquiring purchase information including customer information about a customer who takes a purchase action and billed amount information for the purchase action, and storing, in a storage means, the customer information and the billed amount information in association with each other;

a fixing step of acquiring a settlement request including the customer information, and then fixing a billing content, based on the billed amount information being stored in association with the customer information included in the acquired settlement request;

and a settlement step of performing settlement processing, based on the fixed billing content.

Further, the present invention provides a processing device including:

a billing information registration means for acquiring purchase information including customer information about a customer who takes a purchase action and billed amount information for the purchase action, and storing, in a storage unit, the customer information and the billed amount information in association with each other; and

a fixing means for acquiring a settlement request including the customer information, then fixing a billing content, based on the billed amount information being stored in association with the customer information included in the acquired settlement request, and outputting billing content information indicating the fixed billing content.

Further, the present invention provides a settlement system including:

a processing device; a temporary settlement terminal; and a settlement terminal, wherein

the processing device includes
a billing information registration means for acquiring, from the temporary settlement terminal, purchase information including customer information about a customer who takes a purchase action and billed amount information for the purchase action, and storing, in a storage means, the customer information and the billed amount information in association with each other, and
a fixing means for acquiring, from the settlement terminal, a settlement request including the customer information, then fixing a billing content, based on the billed amount information being stored in association with the customer information included in the acquired settlement request, and outputting, to the settlement terminal, billing content information indicating the fixed billing content.

Further, the present invention provides a settlement system including

a temporary settlement terminal and a settlement terminal, wherein

the temporary settlement terminal includes a billing information registration means for acquiring purchase information including customer information about a customer who takes a purchase action and billed amount information for the purchase action, and storing, in a storage means, the customer information and the billed amount information in association with each other, and

the settlement terminal includes a fixing means for acquiring a settlement request including the customer information, and then fixing a billing content, based on the billed amount information being stored in association with the customer information included in the acquired settlement request, and a settlement means for performing settlement processing, based on the fixed billing content.

Further, the present invention provides a program causing a computer to function as:

a billing information registration means for acquiring purchase information including customer information about a customer who takes a purchase action and billed amount information for the purchase action, and storing, in a storage means, the customer information and the billed amount information in association with each other; and

a fixing means for acquiring a settlement request including the customer information, then fixing a billing content, based on the billed amount information being stored in association with the customer information included in the acquired settlement request, and outputting billing content information indicating the fixed billing content.

### Advantageous Effects of Invention

The present invention is able to reduce inconvenience that may occur due to a settlement being made at each store for each purchase.

### BRIEF DESCRIPTION OF DRAWINGS

FIG. 1 is one example of a functional block diagram of a settlement system according to the present example embodiment.

FIG. 2 is a diagram illustrating one example of a hardware configuration of a processing device, a temporary settlement terminal, and a settlement terminal according to the present example embodiment.

FIG. 3 is one example of a functional block diagram of the processing device according to the present example embodiment.

FIG. 4 is a sequence diagram illustrating one example of a flow of processing of the settlement system according to the present example embodiment.

FIG. 5 is a diagram schematically illustrating one example of information processed by the processing device according to the present example embodiment.

FIG. 6 is a diagram schematically illustrating one example of information processed by the processing device according to the present example embodiment.

FIG. 7 is a diagram illustrating one example of a screen output from the settlement terminal according to the present example embodiment.

FIG. 8 is one example of a functional block diagram of a processing device according to the present example embodiment.

FIG. 9 is a sequence diagram illustrating one example of a flow of processing of a settlement system according to the present example embodiment.

FIG. 10 is a diagram schematically illustrating one example of information processed by the processing device according to the present example embodiment.

FIG. 11 is a diagram schematically illustrating one example of information processed by the processing device according to the present example embodiment.

FIG. 12 is a diagram illustrating one example of a screen output from a temporary settlement terminal according to the present example embodiment.

FIG. 13 is a diagram schematically illustrating one example of information processed by the processing device according to the present example embodiment.

FIG. 14 is a diagram illustrating one example of a screen output from the settlement terminal according to the present example embodiment.

FIG. 15 is a sequence diagram illustrating one example of a flow of processing of a settlement system according to the present example embodiment.

FIG. 16 is a diagram schematically illustrating one example of information processed by the processing device according to the present example embodiment.

FIG. 17 is a diagram schematically illustrating one example of information processed by a processing device according to the present example embodiment.

FIG. 18 is a diagram schematically illustrating one example of information processed by the processing device according to the present example embodiment.

FIG. 19 is a diagram schematically illustrating one example of information output from the temporary settlement terminal according to the present example embodiment.

### EXAMPLE EMBODIMENT

### First Example Embodiment

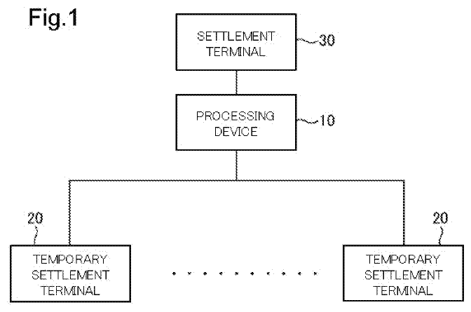

First, an overall perspective and an outline of a settlement system according to the present example embodiment will be described by using FIG. 1. The settlement system achieves a “deferred settlement service” capable of making a temporary settlement at each store for each purchase at each store, and collectively making settlements later. The “temporary settlement” refers to registration, with the settlement system, of a price of a purchased product and a purchased service, and the like in association with a customer. The “settlement” refers to a payment of a price of a purchased product and a purchased service by using any means such as cash, a credit card, and a point.

As illustrated, the settlement system includes a processing device 10, a plurality of temporary settlement terminals 20, and a settlement terminal 30. The settlement terminal 30 may be one or plural. The processing device 10 and the temporary settlement terminal 20 are connected communicably to each other. Further, the processing device 10 and the settlement terminal 30 are connected communicably to each other.

An outline of each of the processing device 10, the temporary settlement terminal 20, and the settlement terminal 30 is as follows.

The temporary settlement terminal 20 is installed at a store that takes part in the deferred settlement service. Then, the temporary settlement terminal 20 acquires purchase information of an amount of a deferred settlement, and transmits the purchase information to the processing device 10. The purchase information includes billed amount information indicating a billed amount being calculated based on a price of a purchased product and a purchased service, customer information about a customer who receives the deferred settlement service (hereinafter, may be simply referred to as a “customer”), and the like. The processing device 10 registers the purchase information acquired from the temporary settlement terminal 20. Hereinafter, processing by the processing device 10 of acquiring purchase information of an amount of a deferred settlement from the temporary settlement terminal 20 and registering the purchase information is referred to as “temporary settlement processing”.

The settlement terminal 30 is installed at any place. For example, the settlement terminal 30 may be installed at a store that takes part in the deferred settlement service, may be installed in any position inside a facility (a shopping mall, for example) and an area (a hot spring resort area, for example) in which a plurality of stores that take part in the deferred settlement service are located, may be installed in a public facility such as a station, and may be installed in a financial institution such as a bank and a post office. Note that the temporary settlement terminal 20 and the settlement terminal 30 may be separated physically and/or logically, and may be integrally formed physically and logically.

The settlement terminal 30 performs processing of collectively making settlements of an amount registered with the processing device 10 by the temporary settlement processing. When receiving an input of customer information, the settlement terminal 30 acquires, from the processing device 10, information (hereinafter, also referred to as a billing content) indicating a billing content being calculated based on purchase information that is registered in association with the customer information. Then, the settlement terminal 30 makes a settlement, based on the acquired billing content. For example, the settlement terminal 30 receives an input of cash, an input of credit card information, an input of a point card, and the like, and makes a settlement of a billed amount indicated by the billing content, based on the inputs. The settlement terminal 30 may be connected to a server of a credit card company and a server of a settlement agency via a network. When the settlement is completed, the settlement terminal 30 notifies the processing device 10 of the completion. The processing device 10 updates stored information (information related to the temporary settlement processing), based on the notification content. Hereinafter, processing by the processing device 10 of notifying the settlement terminal 30 of a billing content being fixed based on information registered in the temporary settlement processing is referred to as “fixing processing”.

The processing device 10 includes a means for performing initial registration processing of registering various pieces of information related to a customer who receives the deferred payment service, a means for performing the temporary settlement processing by communicating with the temporary settlement terminal 20, and a means for performing the fixing processing by communicating with the settlement terminal 30.

Next, a configuration of the settlement system will be described in detail. First, one example of a hardware configuration of the processing device 10, the temporary settlement terminal 20, and the settlement terminal 30 will be described. Each functional unit of the processing device 10, the temporary settlement terminal 20, and the settlement terminal 30 is achieved by any combination of hardware and software concentrating on a central processing unit (CPU) of any computer, a memory, a program loaded into the memory, a storage unit (that can also store a program downloaded from a storage medium such as a compact disc (CD), a server on the Internet, and the like in addition to a program being previously stored at a stage of shipping of a device) such as a hard disc that stores the program, and a network connection interface. Then, a person skilled in the art understands that a method and a device of achieving each functional unit have various modification examples.

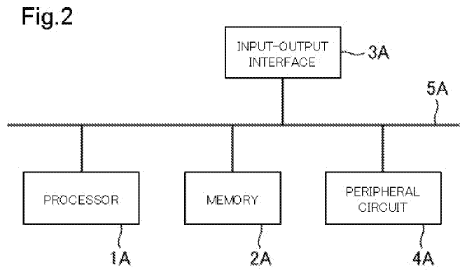

FIG. 2 is a block diagram exemplifying a hardware configuration of the processing device 10, the temporary settlement terminal 20, and the settlement terminal 30. As illustrated in FIG. 2, each of the processing device 10, the temporary settlement terminal 20, and the settlement terminal 30 includes a processor 1A, a memory 2A, an input-output interface 3A, a peripheral circuit 4A, and a bus 5A. Various modules are included in the peripheral circuit 4A. The processing device 10, the temporary settlement terminal 20, and the settlement terminal 30 may not include the peripheral circuit 4A. Note that the processing device 10, the temporary settlement terminal 20, and the settlement terminal 30 may be formed of a plurality of devices being separated physically and/or logically. In this case, each of the plurality of devices can include the hardware configuration described above.

The bus 5A is a data transmission path for the processor 1A, the memory 2A, the peripheral circuit 4A, and the input-output interface 3A to transmit and receive data to and from each other. The processor 1A is an arithmetic processing device such as a CPU and a graphics processing unit (GPU), for example. The memory 2A is a memory such as a random access memory (RAM) and a read only memory (ROM), for example. The input-output interface 3A includes an interface for acquiring information from an input device, an external device, an external server, an external sensor, a camera, and the like, an interface for outputting information to an output device, an external device, an external server, and the like, and the like. The input device is, for example, a keyboard, a mouse, a microphone, a physical button, a touch panel, and the like. The output device is, for example, a display, a speaker, a printer, a mailer, and the like. The processor 1A can output an instruction to each of modules, and perform a computation, based on an arithmetic result of the modules.

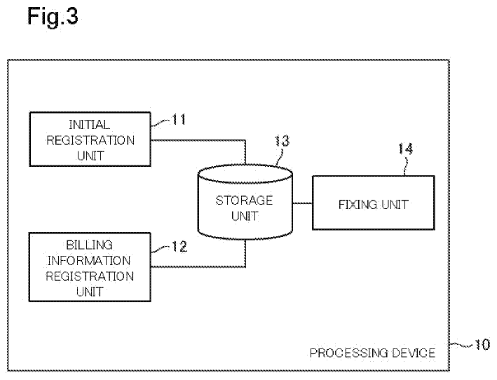

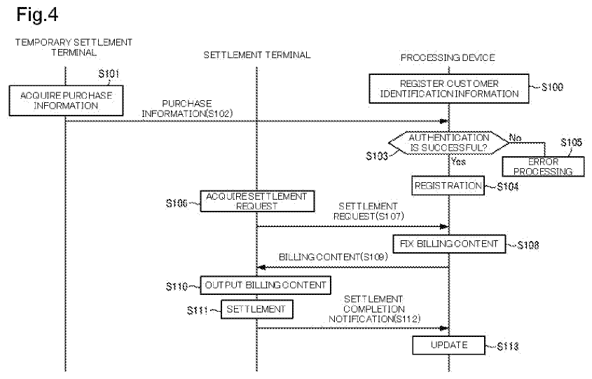

Next, a flow of processing of the settlement system and a functional configuration of each of the processing device 10, the temporary settlement terminal 20, and the settlement terminal 30 will be described by using a functional block diagram in FIG. 3 and a sequence diagram in FIG. 4.

FIG. 3 is one example of the functional block diagram of the processing device 10. As illustrated, the processing device 10 includes an initial registration unit 11, a billing information registration unit 12, a storage unit 13, and a fixing unit 14. The initial registration unit 11 performs initial registration processing of registering various pieces of information related to a customer who receives the deferred payment service. The billing information registration unit 12 performs the temporary settlement processing by communicating with the temporary settlement terminal 20. The fixing unit 14 outputs a billing content to the settlement terminal 30. The storage unit 13 stores various pieces of information. Note that the processing device 10 may not include the storage unit 13. In this case, an external device connected communicably to the processing device 10 includes the storage unit 13.

FIG. 4 illustrates one example of a flow of processing performed by the settlement system until a customer who receives the deferred payment service registers various pieces of information related to himself/herself (initial registration), makes a purchase using the deferred payment service at a store that takes part in the deferred payment service, and then makes a deferred payment of the purchase at the store.

### Initial Registration Processing

In S100 (initial registration step), the initial registration unit 11 of the processing device 10 performs the initial registration processing of registering various pieces of information related to a customer. The customer inputs various pieces of information by operating any operation device, and performs an instruction input to be registered. Then, the operation device transmits various pieces of the input information to the processing device 10. The initial registration unit 11 performs the initial registration processing, based on various pieces of the received information.

The operation device may be the temporary settlement terminal 20 and/or the settlement terminal 30. In this case, the temporary settlement terminal 20 and/or the settlement terminal 30 have a function of receiving an input of various pieces of information for the initial registration, and transmitting various pieces of the input information to the processing device 10. In addition, the operation device may be any communication terminal (such as a smartphone, a tablet terminal, a personal computer (PC), and a cellular phone). In this case, the communication terminal can perform processing of receiving an input of various pieces of information for the initial registration via a predetermined Web page and a predetermined application, and transmitting various pieces of the input information to the processing device 10. The customer can perform an input of the various pieces of the information above and a registration instruction by operating the operation device as described above at any timing before a purchase using the deferred payment service for the first time at a store that takes part in the deferred payment service. For example, the customer may perform an input of the various pieces of the information above and a registration instruction by operating any communication terminal before the customer visits a store that takes part in the deferred payment service. In addition, the customer may perform an input of the various pieces of the information above and a registration instruction by visiting a store that takes part in the deferred payment service for the first time and operating the temporary settlement terminal 20, the settlement terminal 30, or any communication terminal at the store immediately before the customer makes a purchase using the deferred payment service for the first time.

Various pieces of the information can include information indicating a status such as a name, a date of birth, an address, a phone number, and an age. Further, various pieces of the information can include authentication information for authenticating each customer.

The authentication information may biometric information about a customer. Examples of the biometric information include facial information (such as a facial image data and a feature amount extracted from a facial image data), fingerprint information (such as a fingerprint image data and a feature amount extracted from a fingerprint image data), voice information (such as a voiceprint data and a feature amount extracted from voice data), iris information (such as an iris image data and a feature amount extracted from an iris image data), and ear information (information indicating an acoustic characteristic of an ear hole), which is not limited thereto. The biometric information is acquired by a biometric sensor (such as a camera, finger print sensor, or microphone). Note that the authentication information may be other information such as a password. The password may be determined by a customer himself/herself or may be determined by the processing device 10.

Further, various pieces of the information may also include payment related information such as credit card information (such as a name on a card, a card number, and an expiration date), point information (such as a membership number of a service that handles a point usable for a settlement), and prepaid electronic money information (such as a membership number of a service that handles the electronic money).

Further, the initial registration unit 11 may receive charging of money. Then, various pieces of the information may include a charged amount. Examples of a means for achieving charging include an input of cash to the temporary settlement terminal 20 and the settlement terminal 30, a credit card settlement, use of a point, an electronic money settlement, and a bank transfer, which is not limited thereto.

The operation device can receive an input of the various pieces of the information via any input device such as a touch panel display, a physical button, a microphone, a keyboard, and a mouse. Further, the operation device can receive an input of the biometric information via any input device such as a camera, a fingerprint sensor, and an earphone. Further, the operation device can receive an input of the payment related information via any input device such as a card reader.

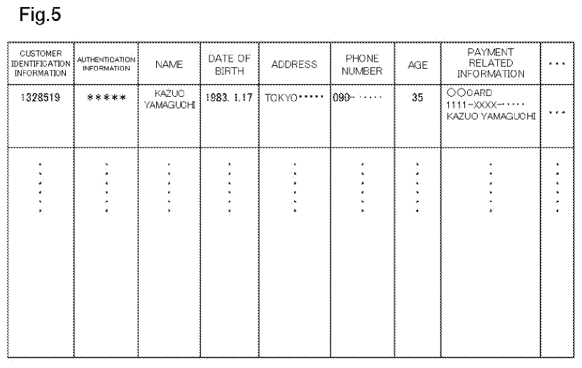

When information of a necessary item for predetermined initial registration is available in various pieces of information acquired from the operation device, the initial registration unit 11 issues customer identification information in association with a customer. Then, the initial registration unit 11 stores, in the storage unit 13, various pieces of the acquired information and the issued customer identification information in association with each other. FIG. 5 schematically illustrates one example of information stored in the storage unit 13 by the initial registration unit 11. In the illustrated example, customer identification information, authentication information, a name, a date of birth, an address, a phone number, an age, and payment related information are associated with each other. Hereinafter, the information stored in the storage unit 13 by the initial registration unit 11 is referred to as customer registration information.

Note that some of various pieces of the information exemplified above may not be included in the necessary item for the initial registration. In this case, the initial registration unit 11 may receive registration of information of an item other than the necessary item for the initial registration via the operation device at any timing after the initial registration.

In this way, the initial registration unit 11 stores customer information including at least one piece of customer identification information that identifies a customer and authentication information in the storage unit 13.

Note that, in the present specification, “acquisition” includes at least any one of “acquisition, by its own device, of data stored in another device or a storage medium (active acquisition)”, based on a user input or an instruction of a program, such as reception by making a request or an inquiry to another device and reading by accessing to another device or a storage medium, “inputting, to its own device, of data output from another device (passive acquisition)”, based on a user input or an instruction of a program, such as reception of data to be distributed (transmitted, push-notified, or the like) and acquisition by selection from among received data or received information, and “generation of new data by editing data (such as texting, sorting of data, extraction of a part of data, and change of a file format) and the like, and acquisition of the new data”.

### Temporary Settlement Processing

Referring back to FIG. 4, after the initial registration in S100 is completed, the customer can make a purchase using the deferred payment service at a store that takes part in the deferred payment service. In S101, the temporary settlement terminal 20 installed at the store that takes part in the deferred payment service acquires purchase information related to the purchase of the customer.

The purchase information includes at least customer information about a customer who takes a purchase action and information (hereinafter, also referred to as billed amount information) indicating a billed amount for the purchase action. The purchase action includes purchasing an article and receiving provision of a service. The billed amount information is calculated based on a price of a purchased product and a purchase service. The customer information includes at least one of customer identification information and authentication information about the customer. In addition, the purchase information may also include a date and time of a purchase, information (store identification information) that identifies a store where a purchase is made, information (such as a product name and a service name) indicating a purchased product and a purchased service, and the like.

The temporary settlement terminal 20 can receive an input of the customer information via any input device such as a touch panel display, a physical button, a microphone, a keyboard, a mouse, a card reader, a camera, a fingerprint sensor, and an earphone.

Further, the temporary settlement terminal 20 can acquire a billed amount, a date and time of a purchase, store identification information, information indicating a purchased product and a purchased service, and the like from an accounting device (such as a point of sales (POS) register) installed at a store by communicating with the accounting device. Note that the temporary settlement terminal 20 may receive an input of the information via any input device such as a touch panel display, a physical button, a microphone, a keyboard, and a mouse. The temporary settlement terminal 20 and the accounting device may be separated physically and/or logically, and may be integrally formed physically and logically.

In S102, the temporary settlement terminal 20 transmits the purchase information acquired in S101 to the processing device 10. The processing device 10 acquires the purchase information transmitted from the temporary settlement terminal 20.

In S103, the billing information registration unit 12 of the processing device 10 performs authentication processing using customer information included in the purchase information acquired in S102. The billing information registration unit 12 may perform biometric authentication using biometric information, may perform password authentication using customer identification information and a password, and may perform other authentication. For example, the billing information registration unit 12 performs a verification step of verifying biometric information included in the purchase information acquired in S102 against biometric information stored in the storage unit 13.

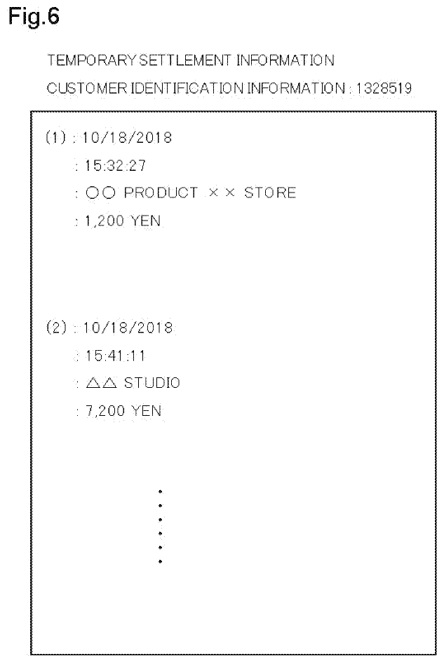

When the authentication is successful (Yes in S103), the billing information registration unit 12 registers a billed amount and the customer information included in the purchase information acquired in S102 (S104, billing information registration step). In other words, the billing information registration unit 12 stores, in the storage unit 13, the billed amount and the customer information in association with each other. Hereinafter, information in which a billed amount and customer information being stored in the storage unit 13 by the billing information registration unit 12 are associated with each other is referred to as temporary settlement information. FIG. 6 schematically illustrates one example of the temporary settlement information. In the illustrated example, purchase information about two purchases is illustrated. A billed amount of a first purchase is 1200 yen, and a billed amount of a second purchase is 7200 yen.

Referring back to FIG. 4, when the authentication is unsuccessful (No in S103), the billing information registration unit 12 performs error processing (S105). For example, the billing information registration unit 12 may notify the temporary settlement terminal 20 that the authentication is unsuccessful. In this case, the temporary settlement terminal 20 outputs information indicating that the authentication is unsuccessful via an output device such as a display, a speaker, and a warning lamp.

The customer can make purchases using the deferred payment service for a plurality of times before making a settlement of a deferred payment. The illustrated example illustrates a flow in which the settlement system performs the processing from S101 to S105 only once. However, the settlement system can perform the processing from S101 to S105 for a plurality of times before performing processing in and after S106. As a result, as illustrated in FIG. 6, the information related to the purchases for the plurality of times using the deferred payment service is registered in the temporary settlement information.

### Fixing Processing

Referring back to FIG. 4, the customer makes a settlement by operating the settlement terminal 30 at any timing after a purchase using the deferred payment service at a predetermined store. First, the customer inputs customer information by operating the settlement terminal 30, and also inputs a request to start the settlement.

The settlement terminal 30 acquires the settlement request including the customer information by the input (S106). Then, the settlement terminal 30 transmits the acquired settlement request to the processing device 10 (S107).

When acquiring the settlement request transmitted from the settlement terminal 30, the fixing unit 14 of the processing device 10 fixes a billing content, based on billed amount information (billed amount in the temporary settlement information, see FIG. 6) being stored in the storage unit 13 in association with the customer information included in the acquired settlement request (S108: fixing step). For example, the fixing unit 14 adds billed amounts being indicated by the billed amount information stored in the storage unit 13 in association with the customer information included in the settlement request, calculates a total billed amount, and fixes the total billed amount as a billing content.

Then, the fixing unit 14 transmits the fixed billing content to the settlement terminal 30, and makes the settlement (S109: fixing step).

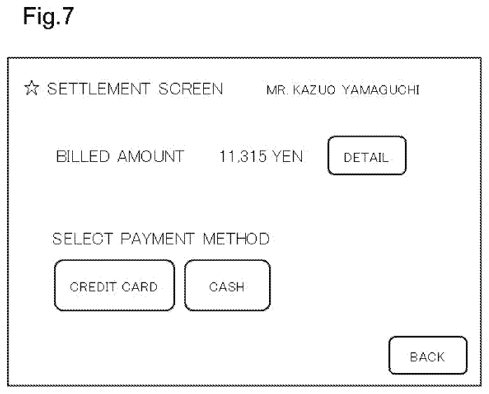

The settlement terminal 30 outputs the billing content via an output device such as a display and a speaker (S110). FIG. 7 illustrates one example of information output from the settlement terminal 30. The illustrated information indicates a billed amount. When an operation (touch operation) is performed on a detailed button displayed on a side of the billed amount, the settlement terminal 30 outputs a breakdown of the billed amount. For example, the settlement terminal 30 may output the information as illustrated in FIG. 6. The settlement terminal 30 can acquire the temporary settlement information from the processing device 10, and achieve an output of the information as illustrated in FIG. 6.

Further, in the example illustrated in FIG. 7, a button for selecting a payment method is displayed. The settlement terminal 30 receives an input of selecting a desired payment method. Then, the settlement terminal 30 makes the settlement by the selected method (S111: settlement step). For example, the settlement terminal 30 receives an input of cash, an input of credit card information, an input of a point card, and the like, and makes the settlement, based on the inputs. In other words, the plurality of stores each have at least two payment methods, including the payment methods of, e.g., credit card, cash, debit card, and point card.

Referring back to FIG. 4, when the settlement is completed, the settlement terminal 30 notifies the processing device 10 that the settlement is completed (S112). The billing information registration unit 12 of the processing device 10 updates the temporary settlement information stored in the storage unit 13 in response to the notification (S113). For example, the billing information registration unit 12 may delete a billed amount related to a purchase having a settlement being completed and the like from the temporary settlement information, or may add information indicating that a settlement is completed to the billed amount and the like.

Next, one example of usage scenes of the settlement system will be described. For example, the settlement system can be used in a facility and an area where a plurality of stores are present, such as a hot spring resort area, a shopping center, and a shopping mall. In this case, a plurality of stores present in one facility or one area take part in the deferred payment service. A customer can use the deferred payment service for a purchase at a store in the facility or the area.

As another example, a company having a plurality of stores dotted with many places can use the settlement system. In this case, a plurality of stores of one company take part in the deferred payment service. A customer can use the deferred payment service for a purchase at a store of the company.

As another example, a community of a plurality of companies having one or a plurality of stores dotted with many places can use the settlement system. In this case, a plurality of stores of a plurality of companies belonging to one community take part in the deferred payment service. A customer can use the deferred payment service for a purchase at a store of the plurality of companies belonging to the community.

Note that the exemplification of the usage scenes herein is merely one example, and a usage scene is not limited to the example exemplified here.

Next, an action effect of the settlement system according to the present example embodiment will be described. According to the settlement system, a customer does not need to make a settlement each time a purchase is made at a store, and can collectively make settlements later. Thus, the customer can avoid troublesome work of taking cash, a credit card, and the like out of a wallet each time a purchase is made at each store, and making a settlement. Further, the customer can pay later, and can thus make a purchase without bringing cash, a credit card, and the like. Thus, inconvenience (loss due to theft, robbery, mislaying, drop, and the like) that may occur by carrying cash, a credit card, and the like can be reduced. Further, each store does not need to introduce a system of a credit card settlement simultaneously with a system of biometric authentication, and thus an obstacle when a system of a biometric authentication settlement is newly introduced is reduced. In other words, a store more easily takes part in the deferred payment service.

### Second Example Embodiment

A settlement system according to the present example embodiment is different from the first example embodiment in that the settlement system according to the present example embodiment has a function of determining an upper limit amount of a temporary settlement for each consumer, and permitting the temporary settlement within a range of equal to or less than the determined upper limit amount. The other configuration of the settlement system according to the present example embodiment is similar to the settlement system according to the first example embodiment. Hereinafter, a point different from the settlement system according to the first example embodiment will be described.

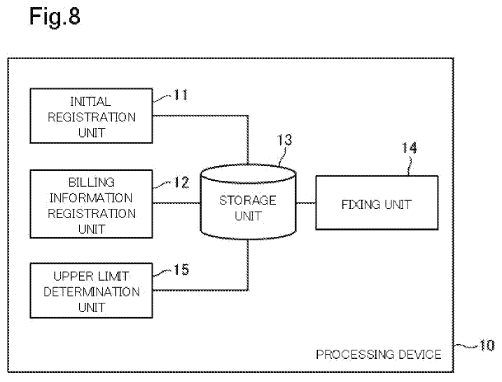

FIG. 8 is one example of a functional block diagram of a processing device 10. As illustrated, the processing device 10 includes an initial registration unit 11, a billing information registration unit 12, a storage unit 13, a fixing unit 14, and an upper limit determination unit 15.

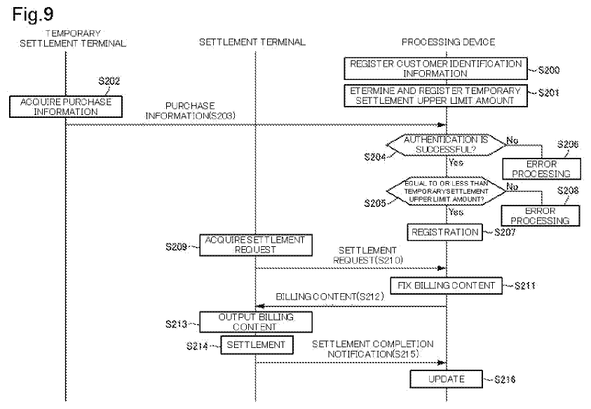

A sequence diagram in FIG. 9 illustrates one example of a flow of processing of the settlement system.

### Initial Registration Processing

Processing in S200 is similar to the processing in S100 in FIG. 4 described in the first example embodiment.

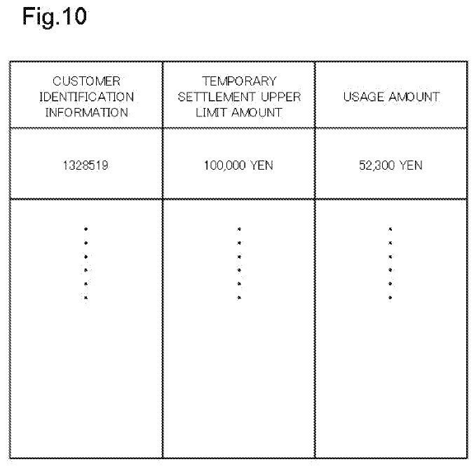

In S201 (upper limit determination step), the upper limit determination unit 15 of the processing device 10 acquires determination material information related to a customer. Then, the upper limit determination unit 15 determines a temporary settlement upper limit amount of the customer, based on the determination material information, and stores, in the storage unit 13, information (hereinafter, also referred to as temporary settlement upper limit amount information) indicating the determined temporary settlement upper limit amount in association with customer information. FIG. 10 schematically illustrates one example of information stored in the storage unit 13 by the upper limit determination unit 15. In the illustrated example, customer identification information, temporary settlement upper limit amount information, and usage amount information are registered in association with each other. The usage amount information is updated by the billing information registration unit 12. Details of the usage amount information will be described later.

The determination material information is information indicating at least one of whether credit card information is registered as customer registration information, credit information about a registered credit card, a prepaid amount being previously charged, a balance of a point usable for a settlement, a credibility point being calculated based on a past usage history of a deferred payment service, information indicating a travel content, and an account balance in a financial institution.

The upper limit determination unit 15 can acquire information indicating whether credit card information is registered as customer registration information, based on the customer registration information stored in the storage unit 13. When credit card information is registered as the customer registration information, the upper limit determination unit 15 can determine a higher temporary settlement upper limit amount than that when the credit card information is not registered.

Further, the upper limit determination unit 15 can acquire credit information about a registered credit card from a server of a credit card company. The credit information indicates an upper limit of an amount that can be settled with the credit card. The upper limit determination unit 15 can determine a higher temporary settlement upper limit amount as an amount that can be settled with the credit card is higher.

Further, the upper limit determination unit 15 can acquire information indicating a prepaid amount being previously charged, based on the customer registration information stored in the storage unit 13. The upper limit determination unit 15 can determine a higher temporary settlement upper limit amount as a prepaid amount is higher.

Further, the upper limit determination unit 15 can acquire information indicating a balance of a point usable for a settlement from a server that manages the point. The upper limit determination unit 15 can determine a higher temporary settlement upper limit amount as a balance of a point is higher.

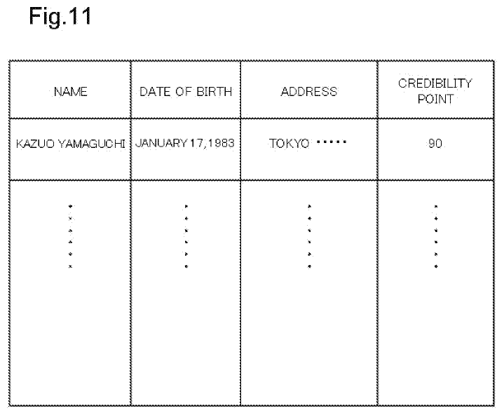

Further, the upper limit determination unit 15 can acquire information indicating a “credibility point being calculated based on a past usage history of a deferred payment service” stored in the storage unit 13 of the processing device 10. FIG. 11 schematically illustrates one example of information that is stored in the storage unit 13 and indicates a credibility point. In the illustrated example, a combination of a name of a customer, a date of birth, and an address, and a credibility point of each customer are registered in association with each other. For example, the credibility point is higher as the number of usage times by normal usage that completes a settlement until a predetermined period is higher. Further, for example, the credibility point is higher as a billed amount by normal usage that completes a settlement until a period is higher. Note that a calculation rule of a credibility point is not limited to these. The upper limit determination unit 15 can determine a higher temporary settlement upper limit amount as a credibility point is higher.

Further, the upper limit determination unit 15 can acquire information indicating a travel content from any server such as a travel agency. The information indicating a travel content includes information indicating a class of a seat of a used airplane, a usage history of a hotel (such as a usage period, the number of usage times, and a grade of a used room), a class of a rental car, and the like. The upper limit determination unit 15 can determine a higher temporary settlement upper limit amount as a class of a seat of a used airplane is higher, a usage period of a hotel is longer, the number of usage times is greater, a grade of a used room is higher, and a class of a rental car is higher.

Further, the upper limit determination unit 15 can acquire information indicating an account balance in a financial institution input by a customer. The upper limit determination unit 15 can determine a higher temporary settlement upper limit amount as an account balance is higher.

### Temporary Settlement Processing

Referring back to FIG. 9, processing in S202 to S204 and S206 is similar to the processing in S101 to S103 and S105 in FIG. 4 described in the first example embodiment.

In S205 (determination step), the billing information registration unit 12 determines whether a total of unsettled billed amounts is equal to or less than a temporary settlement upper limit amount. In other words, the billing information registration unit 12 determines whether a sum of a total of unsettled billed amounts that have been registered and an unsettled billed amount being newly registered is equal to or less than a temporary settlement upper limit amount. For example, the billing information registration unit 12 determines whether a sum of a total of unsettled billed amounts (a total of unsettled billed amounts that have been registered) being stored in the storage unit 13 in association with customer information included in the purchase information acquired in S203 and a billed amount (an unsettled billed amount being newly registered) included in the purchase information acquired in S203 is equal to or less than a temporary settlement upper limit amount being associated with the customer information included in the acquired purchase information.

The usage amount illustrated in FIG. 10 is a total of unsettled billed amounts being stored in the storage unit 13 in association with each piece of customer information. The billing information registration unit 12 determines whether a sum of the usage amount illustrated in FIG. 10 and a billed amount included in the purchase information acquired in S203 is equal to or less than the temporary settlement upper limit amount illustrated in FIG. 10. Note that the purchase information acquired in S203 is registered with the storage unit 13 in S207 when it is Yes in S205, and is not thus stored in the storage unit 13 at a point in time of S205.

Referring back to FIG. 9, when being equal to or less than the temporary settlement upper limit amount (Yes in S205), the billing information registration unit 12 registers the billed amount and the customer information included in the acquired purchase information (S207). The processing is similar to the processing in S104 in FIG. 4 described in the first example embodiment.

On the other hand, when being more than the temporary settlement upper limit amount (No in S205), the billing information registration unit 12 performs error processing (S208). For example, the billing information registration unit 12 may notify a temporary settlement terminal 20 that the temporary settlement upper limit amount is exceeded. In this case, the temporary settlement terminal 20 outputs information indicating that the temporary settlement upper limit amount is exceeded and a temporary settlement cannot be thus made via an output device such as a display, a speaker, and a warning lamp. Note that the temporary settlement terminal 20 may output information indicating a method (such as registration of a charge and credit card information) of increasing the temporary settlement upper limit amount, and receive an operation of increasing the temporary settlement upper limit amount by the method.

### Fixing Processing

Processing in S209 to S216 is similar to the processing in S106 to S113 in FIG. 4 described in the first example embodiment.

Next, an action effect of the settlement system according to the present example embodiment will be described. The settlement system according to the present example embodiment achieves an action effect similar to that of the settlement system according to the first example embodiment. Further, the settlement system according to the present example embodiment can set a temporary settlement upper limit amount appropriate for each customer, and receive a temporary settlement within a range that does not exceed the set temporary settlement upper limit amount. Thus, occurrence of inconvenience in such a way that an amount of a temporary settlement cannot be collected from a customer and the like can be suppressed.

### Third Example Embodiment

A settlement system according to the present example embodiment is different from the first and second example embodiments in that a processing device 10 stores, in a storage unit 13, a billed amount for each customer in association with a payment method being selected at a time of a temporary settlement at each store by each customer. The other configuration of the settlement system according to the present example embodiment is similar to the settlement system according to the first or second example embodiment. Hereinafter, a point different from the settlement system according to the first and second example embodiments will be described.

One example of a functional block diagram of the processing device 10 is illustrated in FIG. 3 or 8. One example of a flow of processing of the settlement system is illustrated by the sequence diagram in FIG. 4 or 9.

### Initial Registration Processing

Processing in S100, S200, and S201 is similar to that in the first and second example embodiments.

### Temporary Settlement Processing

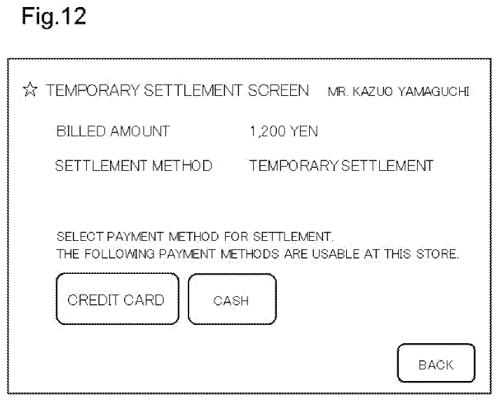

A temporary settlement terminal 20 receives a selection of a payment method in the processing (S101, S202) of acquiring purchase information. For example, the temporary settlement terminal 20 may output a screen as illustrated in FIG. 12. The illustrated screen indicates a billed amount of a purchase this time. Further, an acceptable payment method being set at a store is selectably displayed. Information indicating an acceptable payment method being set at each store may be stored in the processing device 10, may be stored in the temporary settlement terminal 20 being set at each store, and may be stored in another device configured to be communicable with the temporary settlement terminal 20. A customer selects a desired payment method by performing an operation (such as a touch) on a button of the desired payment method.

Referring back to FIGS. 4 and 9, the temporary settlement terminal 20 transmits the purchase information including information indicating the selected payment method to the processing device 10 (S102, S203).

Processing in S103, S105, S204, S205, S206, and S208 is similar to that in the first and second example embodiments.

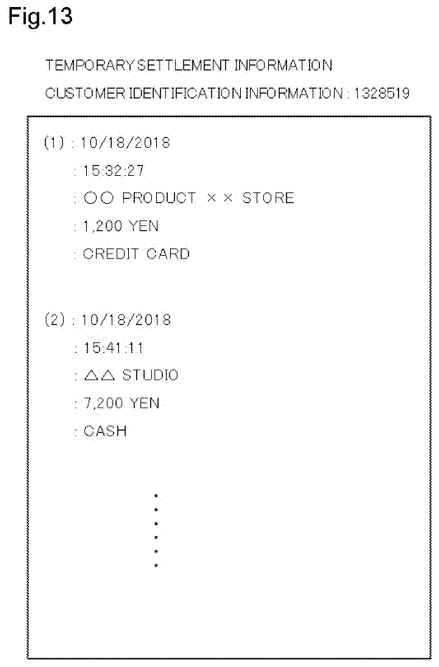

A billing information registration unit 12 acquires the purchase information further including the selected payment method, and stores, in the storage unit 13, a billed amount and the payment method in association with each other (S104, S207: billing information registration step). FIG. 13 schematically illustrates one example of temporary settlement information stored in the storage unit 13 by the billing information registration unit 12. The illustrated temporary settlement information is different from the temporary settlement information illustrated in FIG. 6 in that the illustrated temporary settlement information includes information indicating a payment method selected for each payment.

Note that the billing information registration unit 12 may change a payment method stored in the storage unit 13, based on a customer input, before settlement processing is performed (billing information registration step). A customer can perform a customer input of changing a payment method via the above-described operation device.

### Fixing Processing

Referring back to FIGS. 4 and 9, processing in S106, S107, S109, S112, S113, S209, S210, S212, S215, and S216 is similar to that in the first and second example embodiments.

A fixing unit 14 refers to the temporary settlement information (see FIG. 13), and calculates a total of billed amounts associated with each payment method for each payment method. Then, the fixing unit 14 fixes the total of billed amounts for each payment method as a billing content (S108, S211: fixing step). Then, the fixing unit 14 transmits the fixed billing content to a settlement terminal 30, and makes the settlement (S109, S212: fixing step).

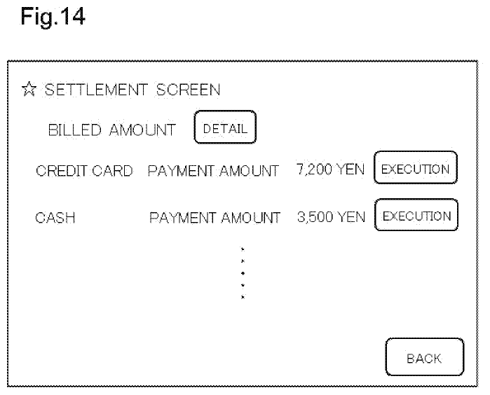

The settlement terminal 30 outputs the billing content via an output device such as a display and a speaker (S110, S213). FIG. 14 illustrates one example of information output from the settlement terminal 30. The illustrated information indicates a billed amount for each payment method. When an operation (touch operation) is performed on a detailed button displayed on a side of the billed amount, the settlement terminal 30 outputs a breakdown of the billed amount. For example, the settlement terminal 30 may output the information as illustrated in FIG. 13. The settlement terminal 30 can acquire the temporary settlement information from the processing device 10, and achieve an output of the information as illustrated in FIG. 13.

Then, when receiving an operation (touch operation) on an execution button, the settlement terminal 30 makes a settlement by each payment method (S111, S214 of FIGS. 4 and 9). For example, the settlement terminal 30 receives an input of cash, an input of credit card information, an input of a point card, and the like, and makes the settlement, based on the inputs.

When the settlement is completed, the settlement terminal 30 notifies the processing device 10 that the settlement is completed (S112, S215). The billing information registration unit 12 of the processing device 10 updates the temporary settlement information stored in the storage unit 13 in response to the notification (S113, S216). For example, the billing information registration unit 12 may delete a billed amount related to a purchase having a settlement being completed and the like from the temporary settlement information, or may add information indicating that a settlement is completed to the billed amount and the like.

Next, an action effect of the settlement system according to the present example embodiment will be described. The settlement system according to the present example embodiment achieves an action effect similar to that of the settlement system according to the first and second example embodiments. Further, according to the settlement system in the present example embodiment, each store can set an acceptable payment method. Thus, a plurality of stores having acceptable payment method different from each other can take part in the same deferred payment service. As a result, a store more easily takes part in the deferred payment service.

### Fourth Example Embodiment

A settlement system according to the present example embodiment is different from the first to third example embodiments in that a settlement period is set, and a processing device 10 performs predetermined processing when the settlement period has elapsed without a settlement being made. The other configuration of the settlement system according to the present example embodiment is similar to the settlement system according to the first, second, or third example embodiment. Hereinafter, a point different from the settlement system according to the first to third example embodiments will be described.

One example of a functional block diagram of the processing device 10 is illustrated in FIG. 3 or 8. A configuration of an initial registration unit 11, a billing information registration unit 12, a storage unit 13, and an upper limit determination unit 15 is similar to that in the first, second, or third example embodiment.

When a fixing unit 14 does not acquire a settlement request even after a lapse of a settlement period, the fixing unit 14 fixes a billing content for each customer, based on billed amount information stored in the storage unit 13 at the point in time (fixing step). Then, the fixing unit 14 notifies the settlement terminal 30 of the fixed billing content, and also notifies the settlement terminal 30 that settlement processing needs to be performed by using at least one of credit card information being initially registered, point information, and a charged amount being previously registered (fixing step). The settlement period can be set arbitrarily. In response to the notification from the fixing unit 14, the settlement terminal 30 performs the settlement processing by using at least one of the credit card information being initially registered, the point information, and the charged amount information being previously registered (settlement step).

Further, when the fixing unit 14 does not acquire a settlement request even after a lapse of a settlement period, the fixing unit 14 can notify a customer of a settlement execution request. For example, when an electronic mail address of a customer is previously registered, the fixing unit 14 may transmit electronic mail including a content that requests settlement execution with, as an address, the electronic mail address of the customer who has not made a settlement even after a lapse of a settlement period. The electronic mail may indicate a billed amount, a breakdown of the billed amount, guidance on a settlement method, and the like.

In addition, the fixing unit 14 may generate a list of names and addresses of customers who have not made a settlement even after a lapse of a settlement period, and output the list. An operator of a deferred payment service can make a notification that requests settlement execution by mail, or make contact by telephone, based on the list. For example, the operator of the deferred payment service may send, to a customer, a transfer form and the like addressed to an address registered at a time of initial registration.

The other configuration of the fixing unit 14 is similar to that in the first, second, or third example embodiment.

Next, an action effect of the settlement system according to the present example embodiment will be described. The settlement system according to the present example embodiment achieves an action effect similar to that of the settlement system according to the first to third example embodiments. Further, the settlement system according to the present example embodiment performs predetermined processing of causing a settlement to be made when a settlement period has elapsed without the settlement being made. Thus, inconvenience in such a way that a state without a settlement being made remains is suppressed.

### Fifth Example Embodiment

A settlement system according to the present example embodiment is different from the first to fourth example embodiments in that a processing device 10 manages a deferred payment service performed by each of a plurality of groups, and also manages which group a deferred payment service being used by each customer belongs to. The other configuration of the settlement system according to the present example embodiment is similar to the settlement system according to the first, second, third, or fourth example embodiment. Hereinafter, a point different from the settlement system according to the first to fourth example embodiments will be described.

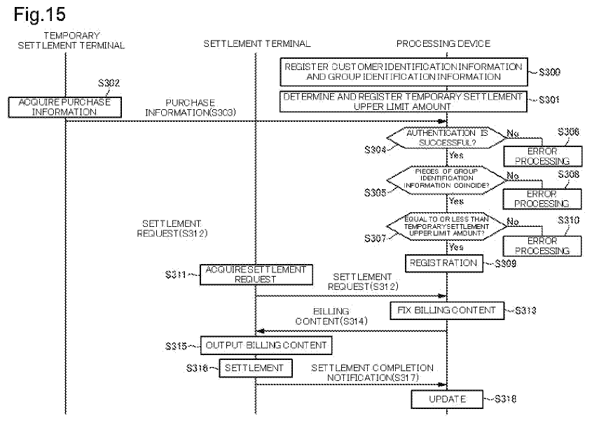

One example of a functional block diagram of the processing device 10 is illustrated in FIG. 3 or 8. A sequence diagram in FIG. 15 illustrates one example of a flow of processing of the settlement system.

### Initial Registration Processing

In S300 (initial registration step), an initial registration unit 11 of the processing device 10 performs initial registration processing of registering various pieces of information related to a customer. The customer inputs various pieces of information by operating any operation device, and performs an instruction input to be registered.

In the present example embodiment, groups to which a plurality of stores belong are independent of each other, and perform a deferred payment service. For example, a group to which a plurality of stores of a first hot spring resort area belong performs a deferred payment service in which the stores take part. Further, a group to which a plurality of stores of a second hot spring resort area belong performs a deferred payment service in which the stores take part.

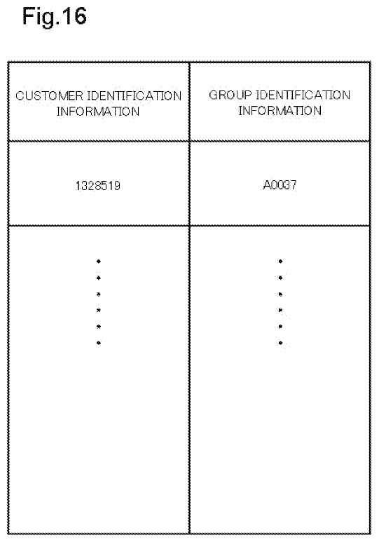

In S300, the customer inputs group identification information that identifies a group for making a purchase using a deferred payment service. Then, the initial registration unit 11 acquires the group identification information, and stores, in a storage unit 13, customer information and the group identification information in association with each other (see FIG. 16). As a modification example, a temporary settlement terminal 20 and a settlement terminal 30 installed at a store may store group identification information about a group to which the store belongs. Then, when various pieces of information for initial registration are input by operating the temporary settlement terminal 20 and the settlement terminal 30, the temporary settlement terminal 20 and the settlement terminal 30 may transmit, to the processing device 10, various pieces of the input information and the group identification information being previously stored in its own terminal in association with each other.

The other processing in S300 is similar to the processing in S100 in FIG. 4 described in the first example embodiment. Further, processing in S301 is similar to the processing in S201 in FIG. 9 described in the second example embodiment.

### Temporary Settlement Processing

Processing in S302 is similar to the processing in S101 in FIGS. 4 and S202 in FIG. 9. In S303, the temporary settlement terminal 20 transmits, to the processing device 10, purchase information further including group identification information about a group to which a store installing its own terminal (the temporary settlement terminal 20) belongs.

Processing in S304 and S306 is similar to the processing in S103 and S105 in FIGS. 4 and S204 and S206 in FIG. 9. A billing information registration step in S305 to S309 is performed by a billing information registration unit 12.

In S305, the billing information registration unit 12 determines whether the group identification information included in the acquired purchase information coincides with the group identification information stored in the storage unit 13 in association with the customer information included in the acquired purchase information. When the pieces of group identification information coincide with each other (Yes in S305), the processing proceeds to S307. When it is Yes in S307, the billing information registration unit 12 associates a billed amount included in the acquired purchase information with the customer information included in the acquired purchase information, and stores, in the storage unit 13, the billed amount and the customer information.

On the other hand, when the pieces of group identification information do not coincide with each other (No in S305), the billing information registration unit 12 performs error processing (S308). For example, since the group whose group identification information is previously registered does not coincide with the group to which the store where a purchase is made belongs, the billing information registration unit 12 may notify the temporary settlement terminal 20 that a purchase using a deferred payment service cannot be made at the store. In this case, the temporary settlement terminal 20 outputs information indicating the content described above via an output device such as a display, a speaker, and a warning lamp. In this way, an unauthorized use by another person, and the like can be suppressed by eliminating a temporary settlement in an unregistered group.

Processing in S307, S309, and S310 is similar to the processing in S104 in FIGS. 4 and S205, S207, and S208 in FIG. 9.

### Settlement Processing

Processing in S311 to S318 is similar to the processing in S106 to S113 in FIGS. 4 and S209 to S216 in FIG. 9.

Next, an action effect of the settlement system according to the present example embodiment will be described. The settlement system according to the present example embodiment achieves an action effect similar to that of the settlement system according to the first to fourth example embodiments. Further, the settlement system according to the present example embodiment can manage a deferred payment service performed by each of a plurality of groups, and also manage which group a deferred payment service being used by each customer belongs to. Thus, simultaneous use of deferred payment services by a plurality of groups can be achieved. As a result, widespread use of deferred payment services is promoted. Further, since which group a deferred payment service being used by each customer belongs to is managed, and only a deferred payment service in a right group can be used, an unauthorized use by a person who illegally acquires customer information about another person, and the like can be suppressed.

Herein, a modification example of the present example embodiment will be described. The processing device 10 may store, in association with each of a plurality of groups, area positional information indicating a position of an area (a hot spring resort area, for example) in which a store group to which each group belongs is located. Then, when various pieces of information for initial registration are input via a communication terminal such as a smartphone, a tablet terminal, a PC, and a cellular phone, the communication terminal may associate various pieces of the input information and communication terminal positional information indicating a current position of its own terminal with each other, and transmit, to the processing device 10, various pieces of the input information and the communication terminal positional information. The communication terminal positional information can be acquired by using any means such as a global positioning system (GPS). Then, the initial registration unit 11 of the processing device 10 identifies which group has an area in which the communication terminal above is located, based on the area positional information and the communication terminal positional information above. Then, group identification information about the identified group and customer information are associated with each other, and are stored in the storage unit 13.

Note that various pieces of information (such as authentication information) about each customer stored in the storage unit 13 may be deleted at predetermined timing. For example, the processing device 10 may repeatedly acquire communication terminal positional information from the communication terminal above, and continue to monitor whether a customer (the communication terminal above) is located in an area of a registered group. Then, when it is determined that the customer (the communication terminal above) leaves the area of the registered group, the processing device 10 may delete various pieces of information (such as authentication information) about the customer from the storage unit 13. When the customer (the communication terminal above) leaves the area of the registered group, there is a high possibility that the customer finishes staying in the area. Thus, there is a low possibility that a temporary settlement and the like are subsequently made. An unauthorized use by another person, and the like can be suppressed by deleting various pieces of the information about the customer at such timing.

### Sixth Example Embodiment

A settlement system according to the present example embodiment is different from the first to fifth example embodiments in that a processing device 10 calculates a total of billed amounts for each store, based on purchase information having settlement processing being completed. The other configuration of the settlement system according to the present example embodiment is similar to the settlement system according to the first, second, third, fourth, or fifth example embodiment. Hereinafter, a point different from the settlement system according to the first to fifth example embodiments will be described.

One example of a functional block diagram of the processing device 10 is illustrated in FIG. 3 or 8. A configuration of an initial registration unit 11, a storage unit 13, and an upper limit determination unit 15 is similar to that in any of the first to fourth example embodiments.

A billing information registration unit 12 acquires purchase information further including store identification information that identifies a store, and stores, in the storage unit 13, a billed amount and the store identification information in association with each other (billing information registration step). The other configuration of the billing information registration unit 12 is similar to that in any of the first to fifth example embodiments.

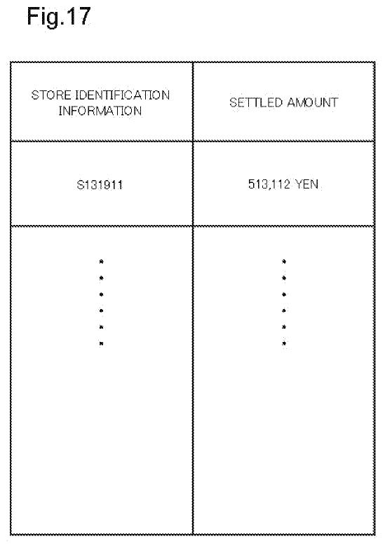

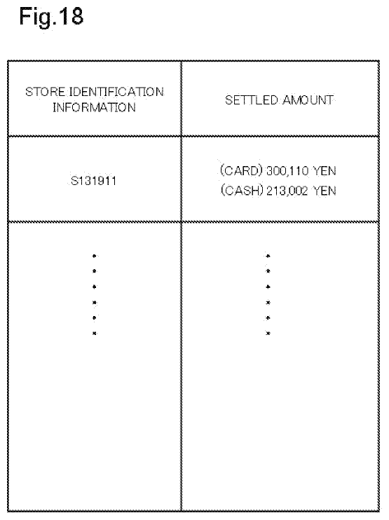

A fixing unit 14 calculates a total of billed amounts for each piece of store identification information, based on purchase information having settlement processing being completed (store-specific information calculation step). FIG. 17 schematically illustrates one example of a result being calculated by the fixing unit 14. In the diagram, a total of billed amounts for each piece of store identification information being calculated by the fixing unit 14 is associated with store identification information. FIG. 18 schematically illustrates another example of a result being calculated by the fixing unit 14. In the diagram, a total of billed amounts for each piece of store identification information and each payment method being calculated by the fixing unit 14 is associated with store identification information. The fixing unit 14 calculates the total at various timings. For example, the fixing unit 14 may calculate the total once a month, once every two weeks, or every day.

When settlement processing calculated by the fixing unit 14 is completed, the processing device 10 can notify each store that the settlement is completed by any means. Further, when the fixing unit 14 calculates a total of billed amounts for each piece of store identification information, the processing device 10 can notify each store of a calculation result by any means.

Next, an action effect of the settlement system according to the present example embodiment will be described. The settlement system according to the present example embodiment achieves an action effect similar to that of the settlement system according to the first to fifth example embodiments. Further, the settlement system according to the present example embodiment can calculate an amount paid to each store that takes part in a deferred payment service.

### Modification Example

Hereinafter, modification examples that are applicable to all of the example embodiments will be described. One or the plurality of modification examples below are applicable to the example embodiments described above.

### Modification Example 1

In the example embodiments described above, it is assumed that the temporary settlement terminal 20 is a device installed at a store. In the modification example, the temporary settlement terminal 20 may be a portable device such as a smartphone, a tablet terminal, and a cellular phone being possessed by a customer. In this case, the temporary settlement terminal 20 may perform short-range wireless communication with an accounting device at a store, and acquire a part or the whole of purchase information (such as a billed amount of a purchase, store identification information, and customer identification information) from the accounting device at the store. In addition, a customer may input a part of the whole of purchase information (such as a billed amount of a purchase, store identification information, and customer identification information) via an input device (such as a touch panel display, a physical button, and a microphone) of a portable device.

### Modification Example 2

Further, it is assumed that the authentication processing (S103, S204, S304) is performed during the temporary settlement processing in the example embodiments described above. In the modification example, the processing device 10 may not perform the authentication processing. In this case, the processing device 10 associates a billed amount included in acquired purchase information with user information included in the acquired purchase information, and stores the billed amount and the user information in the storage unit 13 without performing the authentication processing. Note that the processing device 10 may issue a code (one-dimensional code, two-dimensional code) indicating user identification information in response to initial registration completion. Then, a customer may input the user identification information by causing the temporary settlement terminal 20 to read the code.

### Modification Example 3

Further, information (such as authentication information) stored in the storage unit 13 may be deleted at predetermined timing. For example, when a settlement by the fixing unit 14 is completed or when a predetermined period of time has elapsed since settlement completion without registration of new temporary settlement information, temporary settlement information (see FIGS. 6 and 13) associated with the user identification information and customer registration information (see FIG. 5) related to the user identification information may be accordingly deleted from the storage unit 13. The deletion can suppress an unauthorized use by another person, and the like.

### Modification Example 4

Further, a customer may be able to log in to the processing device 10 via a predetermined Web page and a predetermined application by operating the above-described operation device, and view temporary settlement information accumulated at the point in time.

### Modification Example 5

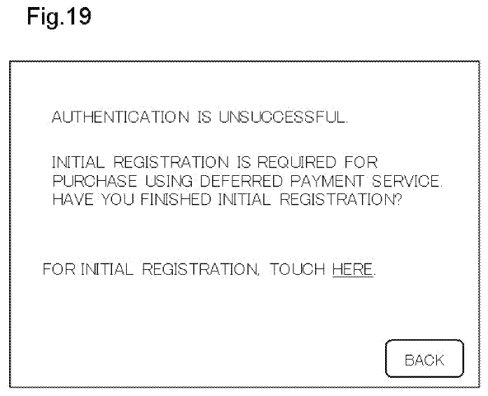

Further, the processing device 10 may acquire purchase information in S102 (see FIG. 4), S203 (see FIGS. 9), and S303 (see FIG. 15), and then perform the initial registration processing in S100, S200, and S201, and S300 and S301. For example, when it is No in S103, S204, and S304 (when authentication is unsuccessful), the processing device 10 may cause the temporary settlement terminal 20 to output a screen illustrated in FIG. 19.

In the illustrated screen, an error message that “Initial registration is required for purchase using deferred payment service. Have you finished initial registration?” is displayed. Further, in the illustrated screen, a guidance message of initial registration that “For initial registration, touch here.” is displayed.

When receiving an operation of touching “here” on the illustrated screen, the temporary settlement terminal 20 requests a screen for initial registration from the processing device 10. Then, the temporary settlement terminal 20 displays the screen for the initial registration being received from the processing device 10, and receives an input of various pieces of information for the initial registration and the like via the screen. Then, the temporary settlement terminal 20 transmits various pieces of the input information to the processing device 10. The processing device 10 performs the initial registration processing in S100, S200, and S201, and S300 and S301, based on various pieces of the received information.

### Modification Example 6

Further, the processing device 10 may perform the authentication processing after S107 (see FIG. 4) and before S 108. Then, the processing device 10 may perform the processing in S108 when authentication is successful, and may perform the error processing when the authentication is unsuccessful. Similarly, the processing device 10 may perform the authentication processing after S210 (see FIG. 9) and before S211. Then, the processing device 10 may perform the processing in S211 when authentication is successful, and may perform the error processing when the authentication is unsuccessful. Further, the processing device 10 may perform the authentication processing after S312 (see FIG. 15) and before S313. Then, the processing device 10 may perform the processing in S313 when authentication is successful, and may perform the error processing when the authentication is unsuccessful.

In a case of the modification example, when receiving an input of a settlement request in S 106, S209, and S311, the settlement terminal 30 receives an input of authentication information. Then, the settlement terminal 30 transmits the authentication information to the processing device 10 in S107, S210, and S312.

### Modification Example 7

Further, the settlement system may include the temporary settlement terminal 20 and the settlement terminal 30, and may not include the processing device 10. In this case, at least one of the temporary settlement terminal 20 and the settlement terminal 30 performs the processing performed by the processing device 10.

For example, the temporary settlement terminal 20 may include the billing information registration unit 12. The temporary settlement terminal 20 may further include the initial registration unit 11. The settlement terminal 30 may include the fixing unit 14, and a settlement unit that performs settlement processing, based on a fixed billing content. Furthermore, the settlement terminal 30 may include the initial registration unit 11.

Note that the storage unit 13 may be included in an external device configured to be communicable with the plurality of temporary settlement terminals 20 and the settlement terminal 30, may be included in one of the plurality of temporary settlement terminals 20, and may be included in one settlement terminal 30 or one of the plurality of settlement terminals 30. In this case, a device including the storage unit 13 communicates with the plurality of temporary settlement terminals 20 and the settlement terminal 30, and updates information in the storage unit 13. In addition, each of the plurality of temporary settlement terminals 20 and the settlement terminal 30 may include the storage unit 13. In this case, the plurality of temporary settlement terminals 20 and the settlement terminal 30 communicate with each other, and synchronize pieces of information stored in the respective storage units 13 (match the pieces of information in such a way that contents coincide with each other).

The invention of the present application is described above with reference to the example embodiments (examples), but the invention of the present application is not limited to the example embodiments (examples) described above. Various modifications that can be understood by those skilled in the art can be made to the configuration and the details of the invention of the present application within the scope of the invention of the present application.

A part or the whole of the above-described example embodiments may also be described as in Supplementary Notes below, which is not limited thereto.
1. A processing method, including:

a billing information registration step of acquiring purchase information including customer information about a customer who takes a purchase action and billed amount information for the purchase action, and storing, in a storage means, the customer information and the billed amount information in association with each other;

a fixing step of acquiring a settlement request including the customer information, and then fixing a billing content, based on the billed amount information being stored in association with the customer information included in the acquired settlement request; and

a settlement step of performing settlement processing, based on the fixed billing content.
2. The processing method according to 1, further including:

an upper limit determination step of acquiring determination material information related to the customer, determining a temporary settlement upper limit amount of the customer, based on the determination material information, associating temporary settlement upper limit amount information indicating the temporary settlement upper limit amount with the customer information, and storing, in the storage means, the temporary settlement upper limit amount information and the customer information; and

a determination step of determining whether a total of unsettled billed amounts is equal to or less than the temporary settlement upper limit amount.
3. The processing method according to 2, wherein

the upper limit determination step includes acquiring the determination material information that indicates at least one of presence or absence of credit card information registration, credit information about a registered credit card, a prepaid amount being previously charged, a balance of a point usable for a settlement, a credibility point being calculated based on a past usage history, information indicating a travel content, and an account balance in a financial institution.
4. The processing method according to any of 1 to 3, wherein

the customer information includes at least any of customer identification information that identifies a customer and authentication information that authenticates the customer, and

the authentication information is biometric information about the customer.
5. The processing method according to 4, further including

a verification step of verifying the biometric information included in the purchase information against the biometric information stored in the storage means.
6. The processing method according to any of 1 to 5, wherein

the billing information registration step includes acquiring the purchase information that further includes payment method information indicating a selected payment method, and storing, in the storage means, the billed amount information and the payment method information in association with each other, and

the fixing step includes fixing, as the billing content, a total of billed amounts indicated by the billed amount information that is calculated for each of the payment methods and is associated with each of the payment methods.
7. The processing method according to 6, wherein

the billing information registration step includes changing the payment method information stored in the storage means, based on a user input, before the settlement processing is performed.
8. The processing method according to any of 1 to 7, wherein

the settlement step includes performing the settlement processing by using at least one of credit card information being initially registered, point information, and charged amount information being previously registered when the settlement request is not acquired even after a lapse of a settlement period.
9. The processing method according to any of 1 to 8, further including

an initial registration step of acquiring group identification information that identifies a group to which a plurality of stores belong, and storing, in the storage means, the customer information and the group identification information in association with each other, wherein

the billing information registration step includes
acquiring the purchase information that further includes the group identification information,
determining whether the group identification information included in the acquired purchase information coincides with the group identification information stored in the storage means in association with the customer information included in the acquired purchase information,
when the pieces of group identification information coincide with each other, associating the billed amount information included in the acquired purchase information with the customer information included in the acquired purchase information, and storing the billed amount information and the customer information in the storage means, and
when the pieces of group identification information do not coincide with each other, performing error processing.
10. The processing method according to any of 1 to 9, wherein

the billing information registration step includes acquiring the purchase information further including store identification information that identifies a store, and stores, in the storage means, the billed amount information and the store identification information in association with each other, and

the processing method further includes a store-specific information calculation step of calculating a total of billed amounts for each piece of the store identification information, based on the purchase information having the settlement processing being completed.
11. A processing device, including:

a billing information registration means for acquiring purchase information including customer information about a customer who takes a purchase action and billed amount information for the purchase action, and storing, in a storage unit, the customer information and the billed amount information in association with each other; and

a fixing means for acquiring a settlement request including the customer information, then fixing a billing content, based on the billed amount information being stored in association with the customer information included in the acquired settlement request, and outputting billing content information indicating the fixed billing content.
12. A settlement system, including:

a processing device; a temporary settlement terminal; and a settlement terminal, wherein

the processing device includes
a billing information registration means for acquiring, from the temporary settlement terminal, purchase information including customer information about a customer who takes a purchase action and billed amount information for the purchase action, and storing, in a storage means, the customer information and the billed amount information in association with each other, and
a fixing means for acquiring, from the settlement terminal, a settlement request including the customer information, then fixing a billing content, based on the billed amount information being stored in association with the customer information included in the acquired settlement request, and outputting, to the settlement terminal, billing content information indicating the fixed billing content.
13. A settlement system, including:

a temporary settlement terminal; and a settlement terminal, wherein

the temporary settlement terminal includes a billing information registration means for acquiring purchase information including customer information about a customer who takes a purchase action and billed amount information for the purchase action, and storing, in a storage means, the customer information and the billed amount information in association with each other, and

the settlement terminal includes a fixing means for acquiring a settlement request including the customer information, and then fixing a billing content, based on the billed amount information being stored in association with the customer information included in the acquired settlement request, and a settlement means for performing settlement processing, based on the fixed billing content.
14. A program causing a computer to function as:

a billing information registration means for acquiring purchase information including customer information about a customer who takes a purchase action and billed amount information for the purchase action, and storing, in a storage means, the customer information and the billed amount information in association with each other; and

a fixing means for acquiring a settlement request including the customer information, then fixing a billing content, based on the billed amount information being stored in association with the customer information included in the acquired settlement request, and outputting billing content information indicating the fixed billing content.

### REFERENCE SIGNS LIST

1A Processor
2A Memory
3A Input-output interface
4A Peripheral circuit
5A Bus
10 Processing device
11 Initial registration unit
12 Billing information registration unit
13 Storage unit
14 Fixing unit
15 Upper limit determination unit
20 Temporary settlement terminal
30 Settlement terminal

1. A processing method, comprising:
acquiring a billed amount for a purchase action and customer information of a customer who takes the purchase action;
Storing the customer information and the billed amount in association with each other;
receiving a settlement request including the customer information;
determining a billing content, based on the billed amount being stored in association with the customer information; and
performing settlement processing, based on the billing content.

2. The processing method according to claim 1, further comprising:
acquiring determination material information related to the customer,
determining a temporary settlement upper limit amount of the customer, based on the determination material information, associating temporary settlement upper limit amount information indicating the temporary settlement upper limit amount with the customer information,
storing the temporary settlement upper limit amount information and the customer information; and
determining whether a total of unsettled billed amounts is equal to or less than the temporary settlement upper limit amount.

3. The processing method according to claim 2, comprising:
acquiring the determination material information that indicates at least one of presence or absence of credit card information registration, credit information about a registered credit card, a prepaid amount being previously charged, a balance of a point usable for a settlement, a credibility point being calculated based on a past usage history, information indicating a travel content, and an account balance in a financial institution.

4. The processing method according to claim 1, wherein
the customer information includes at least any of customer identification information that identifies a customer and authentication information that authenticates the customer; and
the authentication information is biometric information about the customer.

5. The processing method according to claim 4, wherein
verifying the biometric information included in the purchase information against the biometric information.

6. The processing method according to claim 5, wherein
the biometric information is acquired by biometric sensor.

7. The processing method according to claim 5, wherein
the biometric information includes at least one of facial information, fingerprint information, voice information, iris information, and ear information.

8. The processing method according to claim 7, wherein
facial information includes at least one of a facial image and a feature amount extracted from a facial image.

9. The processing method according to claim 1, wherein
acquiring the purchase information further includes acquiring payment method information indicating a selected payment method;
Storing the billed amount information and the payment method information in association with each other; and
fixing, as the billing content, a total of billed amounts indicated by the billed amount information that is calculated for each of the payment methods and is associated with each of the payment methods.

10. The processing method according to claim 6, further comprising
changing the payment method information, based on a user input, before the settlement processing is performed.

11. The processing method according to claim 1, comprising:
performing the settlement processing using at least one of credit card information that has been previously registered, point information, and charged amount information that has been previously registered when a settlement period lapses without the settlement request being acquired.

12. The processing method according to claim 1, further comprising
acquiring group identification information that identifies a group to which a plurality of stores belong, and storing the customer information and the group identification information in association with each other,
acquiring the purchase information that further includes the group identification information,
determining whether the group identification information included in the acquired purchase information coincides with the group identification information in association with the customer information included in the acquired purchase information,
when the pieces of group identification information coincide with each other, associating the billed amount information included in the acquired purchase information with the customer information included in the acquired purchase information, and storing the billed amount information and the customer information, and
when the pieces of group identification information do not coincide with each other, performing error processing.

13. The processing method according to claim 1, comprising;
acquiring the purchase information further including store identification information that identifies a store;
storing the billed amount information and the store identification information in association with each other, and
calculating a total of billed amounts for each piece of the store identification information, based on the purchase information having the settlement processing being completed.

14. A processing device, comprising:
at least one memory configured to store instructions; and
at least one processor configured to execute the instructions to;
acquire customer information about a customer who takes a purchase action and billed amount information for the purchase action;
store the customer information and the billed amount information in association with each other;
receive a settlement request including the customer information;
determine a billing content, based on the billed amount information being stored in association with the customer information included in the acquired settlement request; and
output billing content information indicating the fixed billing content.

15. A non-transitory computer-readable storage medium storing a instructions to cause a computer to execute operations comprising:
acquiring customer information about a customer who takes a purchase action and billed amount information for the purchase action
storing the customer information and the billed amount information in association with each other
receiving a settlement request including the customer information;
determining a billing content, based on the billed amount information being stored in association with the customer information; and
outputting billing content information indicating the fixed billing content.
